(19) United States
(12) Patent Application Publication
(10) Pub. No.: US 2002/0196719 A1
(43) Pub. Date: Dec. 26, 2002

(54) Optical disk recording method and apparatus therefor

(76) Inventor: Morito Morishima, Fukuroi-shi (JP)

Correspondence Address: PILLSBURY MADISON & SUTRO LLP, 725 South Figueroa, Suite 1200, Los Angeles, CA, 90017-5443, US

(21) Appl. No.: 10/155,454

(22) Filed: May 24, 2002

(30) Foreign Application Priority Data
May 24, 2001 (JP) P2001-154785

(51) Int. Cl. G11B 7/00

(52) U.S. Cl. 369/47.53; 369/53.37

(57) ABSTRACT

An optical disk recording apparatus modulates a light beam into recording power by which recording is enabled to be performed and nonrecording power by which recording is not enabled to be performed according to a recording signal. Then, the modulated light beam is irradiated onto a track of an optical disk. Thus, the recording of the recording signal is performed. At that time, periodical variation components of a light beam return light detection output, which are caused owing to axial runouts and eccentricities repeatedly occurring in the optical disk during revolutions of the disk, are detected. Subsequently, the light beam output in a recording power mode is corrected.

### BACKGROUND OF THE INVENTION

This invention generally relates to an optical disk recording method and to an apparatus therefor. More particularly, the invention relates to an optical disk recording method and an apparatus therefor, which are enabled to achieve high-quality recording even when an axial runout (that is, an undulation in a circumferential direction of a surface of a disk substrate) or an eccentricity (that is, a radial runout of a track, such as a guide groove, with respect to the center axis of an optical disk) occurs in the disk, and also enabled to obtain proper recording power even when an axial runout or an eccentricity occurs in the optical disk.

When using recordable optical disks, such as a CD-R (Compact Disk Recordable), a CD-RW (Compact Disk ReWritable), and a DVD-R (Digital Versatile Disk Recordable), before actual recording, test recording is performed at a predetermined test region by sequentially changing there cording power of laser light. After this test recording, the signal quality of a recorded signal is measured by reproducing this recorded signal. Then, recording power, by which the highest-quality of a reproduced signal is obtained according to a result of this measurement, is obtained according to a result of such measurement. Subsequently, the recording power of the laser light is set at the obtained recording power of the laser light. Thus, the actual recording is commenced.

In an optical disk, an axial runout or an eccentricity is caused by a manufacturing error and a change thereof with the lapse of time. When an axial runout is caused therein, an angle, which an optical axis of a laser beam forms with a track, periodically varies by employing one revolution of the disk as one cycle. Moreover, an amount of out-of-focus periodically varies. Thus, an amount (that is, illumination) of laser light irradiated onto a track periodically varies. When an eccentricity occurs in the optical disk, an amount of tracking deviation periodically varies. Thus, the amount of laser light irradiated onto a track periodically varies. Consequently, in the case that an axial runout or an eccentricity is caused in an optical disk, recording quality varies with position in a circumferential direction of the disk even when information is recorded thereon by maintaining recording power at a constant value. Therefore, high-quality recording cannot be achieved all around the disk. Especially, the higher the recording rate is, the more conspicuous this phenomenon is. Further, at the test recording, information is recorded on the disk under the influence of the axial runout or the eccentricity. Thus, it is impossible to obtain optimum recording power with high accuracy.

Incidentally, to cope with change in optimum recording power due to rise in the temperature of a disk substrate during the recording and owing to variation in thickness of recording film in a radial direction of a disk (this variation is caused when the recording film is formed by spin-coating), hitherto, there has been developed a method for obtaining optimum recording power in real time during actual recording by utilizing a technique called “ROPC (Running-Optimum Power Control)” and for controlling the recording power of laser light in such a way as to be adjusted to the detected optimum recording power. However, generally, this method is adapted to cope with change in the condition in the radial direction of the disk, so that a response to the variation is extremely slow, and that this method cannot cope with the axial runout and the eccentricity, which are variations in position within one circumference of the disk.

### SUMMARY OF THE INVENTION

The invention is accomplished in view of the aforementioned respects. Accordingly, an object of the invention is to provide an optical disk recording method, enabled to achieve high-quality recording even when an axial runout or an eccentricity occurs in an optical disk, and also enabled to detect proper recording power with high precision even when an axial runout or an eccentricity occurs therein, and to provide an apparatus therefor.

To achieve the foregoing object, according to an aspect of the invention, there is provided an optical disk recording method (here under referred to as a first method of the invention) for modulating a light beam into recording power, by which recording is enabled to be performed, and nonrecording power, by which recording is not enabled to be performed, according to a recording signal and for irradiating the modulated light beam on to a track of an optical disk to thereby perform recording of the recording signal. According to this method, periodical variation components of a light beam return light detection output, which repeatedly occur in response to revolution of the disk, is detected, and a light beam output in a recording power mode is corrected in such a way as to cancel the periodical variation component. Thus, even when the quantity of laser light irradiated onto a track periodically varies owing to the axial runout and the eccentricity occurring in the optical disk, the light beam output in the recording power mode is corrected in such a way as to cancel the variation, so that high-quality recording is achieved.

According to another aspect of the invention, there is provided an optical disk recording method (hereunder referred to as a second method of the invention) for modulating a light beam into recording power, by which recording is enabled to be performed, and nonrecording power, by which recording is not enabled to be performed, according to a recording signal and for irradiating the modulated light beam onto a track of an optical disk to thereby perform recording of the recording signal. According to this method, a light beam output in a recording power mode is detected and then controlled so that a value thereof is equal to a predetermined target value. Further, periodical variation components of a light beam return light detection output, which are caused in response to revolution of the disk, are detected, and the light beam output in the recording power mode is corrected in a response frequency band, whose frequencies differ from those used for controlling a light beam output according to detection of the optical beam output in the recording power mode, (for example, a response frequency band, whose frequencies are higher than those of a response frequency band of the light beam output control based on the light beam output detection in the recording power mode) in such a way as to cancel the periodical variation components. Thus, a light beam output is restrained by the light beam output control based on the light beam output detection in the recording power mode from varying owing to change in temperature. Moreover, even when the quantity of laser light irradiated onto a track periodically varies owing to the axial runout and the eccentricity occurring in the optical disk, the light beam output in the recording power mode is corrected in such a way as to cancel the variation. Consequently, high-quality recording is achieved.

Incidentally, the detection of the periodical variation component of the light beam return light detection output may be performed, for instance, in real simultaneously with the recording. Alternatively, the detection of the periodical variation component thereof may be performed before the recording is performed. Furthermore, the recording of the recording signal may be performed as, for example, the actual recording. Alternatively, the recording of the recording signal may be performed as the test recording performed by serially changing the recording power so as to obtain proper recording power before the actual recording. Thus, when performed as the actual recording, high-quality printing is achieved. Alternatively, when performed as the test recording, the proper recording power can be obtained with high precision.

According to another aspect of the invention, there is provided an optical disk recording apparatus (hereunder first apparatus of the invention) for modulating a light beam into recording power, by which recording is enabled to be performed, and nonrecording power, by which recording is not enabled to be performed, according to a recording signal and for irradiating the modulated light beam onto a track of an optical disk to thereby perform recording of the recording signal. This apparatus comprises a recording power control loop for detecting a light beam output in a recording power mode, and for controlling the light beam output in the recording power mode so that a value of the light beam output is equal to a predetermined target value, and a nonrecording power control loop for detecting a light beam return light in a nonrecording power mode, and for controlling a return light detection output in the nonrecording power mode so that a value of the light beam output is equal to a predetermined target value. In this apparatus, a response frequency band of the nonrecording power control loop is set in a band in which the nonrecording power control loop responds to periodical variation components of the light beam return light detection output, which are caused in response to revolution of the disk. A response frequency band of the recording power control loop is set in a relatively low-frequency band in which the recording power control loop does not respond to periodical variation components of the light beam return light detection output, which are caused in response to revolution of the disk. Further, during the recording power mode, the recording power control loop drives a light beam source according to asynthetic value of a light beam drive signal, which is generated in the recording power control loop, and a light beam drive signal generated in the nonrecording power control loop, and controls the light beam output so that a value thereof is equal to a predetermined target value in the recording power mode.

An embodiment (hereunder referred to as a second apparatus of the invention) of the first apparatus of the invention further comprises a recording power target value correcting unit for detecting variation in the light beam return light detection output in the recording power mode, which is caused by movement of a recording position in a radial direction of the disk, for generating a correction value, which cancels the variation in the return light detection output in the recording power mode, and for correcting the target value of the recording power control loop by using the correction value. In the second apparatus, a response frequency band of the recording power target value correcting unit is set in a frequency band differing from a response frequency band of the recording power control loop.

According to another aspect of the invention, there is provided an optical disk recording method (hereunder referred to as a third method of the invention) for modulating a light beam into recording power, by which recording is enabled to be performed, and nonrecording power, by which recording is not enabled to be performed, according to a recording signal and for irradiating the modulated light beam onto a track of an optical disk to thereby perform recording of the recording signal. In the case of the third method, periodical variation components of a light beam return light detection output, which repeatedly occur are detected before recording, and the detected periodical variation components are preliminarily stored in a memory as a periodical variation characteristic of the light beam return light output corresponding to circumferential positions on a surface of the disk. Further, during recording, the circumferential positions are sequentially detected, and the periodical variation components of the light beam return light detection output from the memory, which correspond to the circumferential positions on the surface of the disk, are serially read from the memory, and the light beam output in the recording power mode is corrected in such a manner as to cancel the periodical variation components. Thus, even when the quantity of laser light irradiated onto a track periodically varies owing to the axial runout and the eccentricity occurring in the optical disk, the light beam output in the recording power mode is corrected in such a way as to cancel the variation. Consequently, high-quality recording is achieved.

According to another aspect of the invention, there is provided an optical disk recording method (hereunder referred to as a fourth method of the invention) for modulating a light beam into recording power, by which recording is enabled to be performed, and nonrecording power, by which recording is not enabled to be performed, according to a recording signal and for irradiating the modulated light beam onto a track of an optical disk to thereby perform recording of the recording signal. According to this method, periodical variation components of a light beam return light detection output, which repeatedly occur are detected before recording, and the detected periodical variation components are preliminarily stored in a memory as a periodical variation characteristic of the light beam return light output corresponding to circumferential positions on a surface of the disk. Further, when recording is performed, a light beam output in the recording power mode is detected and controlled so that a value of the light beam output is equal to a predetermined target value, and circumferential positions on a surface of the disk are sequentially detected, the periodical variation components of the light beam return light detection output, which correspond to the circumferential positions, are sequentially read from the memory. Furthermore, the light beam output in the recording power mode is corrected in a response frequency band (for example, a response frequency band, whose frequencies are higher than those of the response frequency band of the light beam output control based on the light beam output detection in the recording power mode), which differs from a response frequency band of a light beam output control based on a light beam output detection in the recording power mode, in such a way as to cancel the periodical variation components. Thus, variation in the light beam output is restrained from being caused owing to change in the temperature. Moreover, even when the quantity of laser light irradiated onto a track periodically varies owing to the axial runout and the eccentricity occurring in the optical disk, the light beam output in the recording power mode is corrected in such a way as to cancel the variation. Consequently, high-quality recording is attained.

Incidentally, according to an embodiment (hereunder referred to as a fifth method of the invention) of the third or fourth method of the invention, the detection of the periodical variation components of the light beam return light detecting output, which are repeatedly caused in response to revolutions of the disk, may be performed by, for instance, irradiating a light beam having predetermined power, at which recording is not performed, on the optical disk. Further, the recording of the recording signal may be performed as, for example, an actual recording. Alternatively, the recording of the recording signal may be performed as test recording performed by serially changing the recording power so as to obtain proper recording power before the actual recording.

According to another aspect of the invention, there is provided an optical disk recording apparatus (hereunder referred to as a fourth apparatus of the invention) for modulating a light beam into recording power, by which recording is enabled to be performed, and nonrecording power, by which recording is not enabled to be performed, according to a recording signal and for irradiating the modulated light beam onto a track of an optical disk to thereby perform recording of the recording signal. This apparatus comprises a memory for storing detected characteristics of periodical variation components of a light beam return light detection output, which occur repeatedly in response to revolution of an optical disk mounted in the apparatus, corresponding to each of circumferential positions on a surface of an optical disk,

a recording power control loop for detecting a light beam output in the recording power mode, and for controlling the light beam output in the recording power mode so that a value of the light beam output is equal to a predetermined target value, circumferential position detecting unit for detecting a circumferential position, at which recording is performed, on a surface of the disk, a light beam output correcting unit for serially reading the periodical variation components of the light beam return light detection output, which are caused at corresponding circumferential positions on a surface of an optical disk, from the memory correspondingly to circumferential positions, which are detected by the circumferential position detecting unit, on a surface of the disk and for correcting the light beam output in the recording power mode. In this apparatus, a response frequency band of the recording power control loop is set in a frequency band (for example, a frequency band whose frequencies are relatively low, as compared with those used for the light beam output correction) in which the recording power control loop does not respond to an light beam output correction performed by the light beam output correcting unit.

An embodiment (hereunder referred to as a fifth apparatus of the invention) of the fourth apparatus of the invention further comprises a recording power target value correcting unit for detecting variation in the light beam return light detection output in the recording power mode, which is caused by movement of a recording position in a radial direction of the disk, for generating a correction value, which cancels the variation in the return light detection output in the recording power mode, and for correcting the target value of the recording power control loop by using the correction value. In the fifth apparatus, a response frequency band of the recording power target value correcting unit is set in a frequency band (for example, a frequency band whose frequencies are relatively low, as compared with those of the response frequency band of the recording power control loop) differing from a response frequency band of the recording power control loop.

According to another aspect of the invention, there is provided an optical disk recording method (hereunder referred to as a sixth method of the invention) for modulating a light beam into recording power, by which recording is enabled to be performed, and nonrecording power, by which recording is not enabled to be performed, according to a recording signal and for irradiating the modulated light beam onto a track of an optical disk to thereby perform recording of the recording signal. According to this method, before actual recording, test recording is performed by serially changing the recording power during one revolution of the disk. Further, an asymmetry value in the recording power mode is measured by reproducing data obtained by the test recording. Then, a linear or quadratic approximate recording power value-asymmetry value characteristic is obtained from a value obtained by the measured value. Moreover, a recording power value for realizing a predetermined target value of the asymmetry value from the obtained linear or quadratic approximate characteristic, and the obtained recording power value is set to be an initial recording power command value at start of actual recording to thereby commence the actual recording. That is, when an axial runout and an eccentricity occurs in the optical disk, a sinusoidal-wave-like fluctuation occurs in the recording power value-asymmetry value characteristic. Thus, when the recording power value for realizing the target asymmetry value is obtained from this characteristic, an error with respect to a real recording power value for realizing the target asymmetry value is caused. Consequently, when the actual printing is performed by setting the recording power value at the error value, high-quality printing cannot be achieved. Therefore, a linear or quadratic approximate characteristic is obtained from a result of measurement of the recording power value-asymmetry value characteristic, which is based on the test printing performed during one revolution of the disk. Consequently, influence of the axial runout components and the eccentricity components of the optical disk, which are included in this characteristic, are eliminated. Thus, the recording power value for realizing the target asymmetry value can be obtained with high accuracy. High-quality printing can be achieved by setting the recording power value at the obtained value, and performing the actual recording. Incidentally, the approximate characteristic can be obtained by performing, for instance, a least square method. Furthermore, one revolution of the disk can be detected by counting FG pulses obtained from a FG (Frequency Generator) during the rotation of the disk.

According to another aspect of the invention, there is provided an optical disk recording method for modulating a light beam into recording power, by which recording is enabled to be performed, and nonrecording power, by which recording is not enabled to be performed, according to a recording signal and for irradiating the modulated light beam onto a track of an optical disk to thereby perform recording of the recording signal. According to this method, before actual recording, test recording is performed by serially changing the recording power during one revolution of the disk, and a recording power value-asymmetry value characteristic and an asymmetric value-recording signal quality characteristic are obtained by reproducing data obtained by the test recording. Then, a position of a center of gravity in a direction, in which an asymmetry value changes, is obtained from the asymmetric value-recording signal quality characteristic, and a recoding power value for realizing a predetermined target value of the asymmetry value from the obtained recording power value-asymmetry value characteristic. Furthermore, the obtained recording power value is set to be an initial recording power command value at start of actual recording to thereby commence the actual recording. Thus, a value in the vicinity of the center of the range of the asymmetry value, at which good recording signal quality is obtained, that is, an asymmetry value at which a large power margin is obtained (that is, an asymmetry value at which good recording signal quality is provided and degradation in the recording signal quality owing to variation in the recording power value is low) can be obtained. Thus, a proper asymmetry value can be obtained with high accuracy by employing this asymmetry value as the target asymmetry value and obtaining the recording power value, which is used for realizing the target asymmetry value, from the recording power value-asymmetry value characteristic. Furthermore, the actual recording is performed by setting the recording power value at the obtained value, thereby to achieve high-quality printing. Incidentally, for example, an incidence rate of a C1 error (that is, Reed-Solomon correction 1-level error) and a CU error (uncorrectable error), a dephasing rate, and a jitter amount may be used as a parameter for the recording signal quality.

### BRIEF DESCRIPTION OF THE DRAWINGS

FIG. 1 is a block view illustrating an embodiment of an optical disk recording apparatus according to the invention.

FIG. 2 is a circuit view illustrating the configuration of an example of a laser drive circuit 28 of FIG. 1.

FIGS. 3A to 3D are time charts illustrating sampling timing in sample-and-hold circuits SH1, SH2, and SH3.

FIG. 4 is a graph illustrating change in a recording power command value at test recording.

FIG. 5 is a graph illustrating an example of an asymmetry-value-to-recording-power-value characteristic obtained according to a result of test recording.

FIG. 6 is a graph illustrating an example of a set response frequency band of each of an ALPC1 loop 30, an ALPC2 loop 38, and a ROPC circuit 44.

FIG. 7 is a waveform chart illustrating a periodical variation component due to an axial runout and an eccentricity, which is outputted from a low-pass filter LPF2 of FIG. 1.

FIG. 8 is a flowchart illustrating an example of a control operation performed by an optical disk recording apparatus of FIG. 1.

FIG. 9 is a block view illustrating another embodiment of an optical disk recording apparatus according to the invention.

FIG. 10 is a graph illustrating an example of data stored in a circulating memory 54.

FIG. 11 is a flowchart illustrating a control operation performed by an optical disk recording apparatus of FIG. 9.

FIG. 12 is a flowchart illustrating an embodiment of the optical disk recording method according to the invention.

FIG. 13 is a graph illustrating an example of an asymmetry-value-to-recording-power-value characteristic obtained according to a result of test recording performed according to a method illustrated in FIG. 12.

FIG. 14 is a flowchart illustrating an embodiment of an optical disk recording method according to the invention.

FIG. 15 is a graph illustrating an example of a characteristic of number of times of occurrence of no-C1 error with respect to asymmetry-value which is obtained according to a result of test recording, which is performed by a method illustrated by FIG. 14.

FIG. 16 is a flowchart illustrating an embodiment of an optical disk recording method according to the invention.

FIG. 17A is a graph illustrating an example of a jitter-to-asymmetry-value characteristic obtained by a method illustrated in FIG. 16. FIG. 17B is a graph illustrating the inversion of the characteristic illustrated in FIG. 17A.

### DETAILED DESCRIPTION PREFERRED EMBODIMENTS

Hereinafter, embodiments obtained by applying the invention to a CD-R/RW drive (that is, an optical disk recording apparatus enabled to perform recording of information on and reproducing of information from a CD-R disk and a CD-RW disk) are described.

First Embodiment

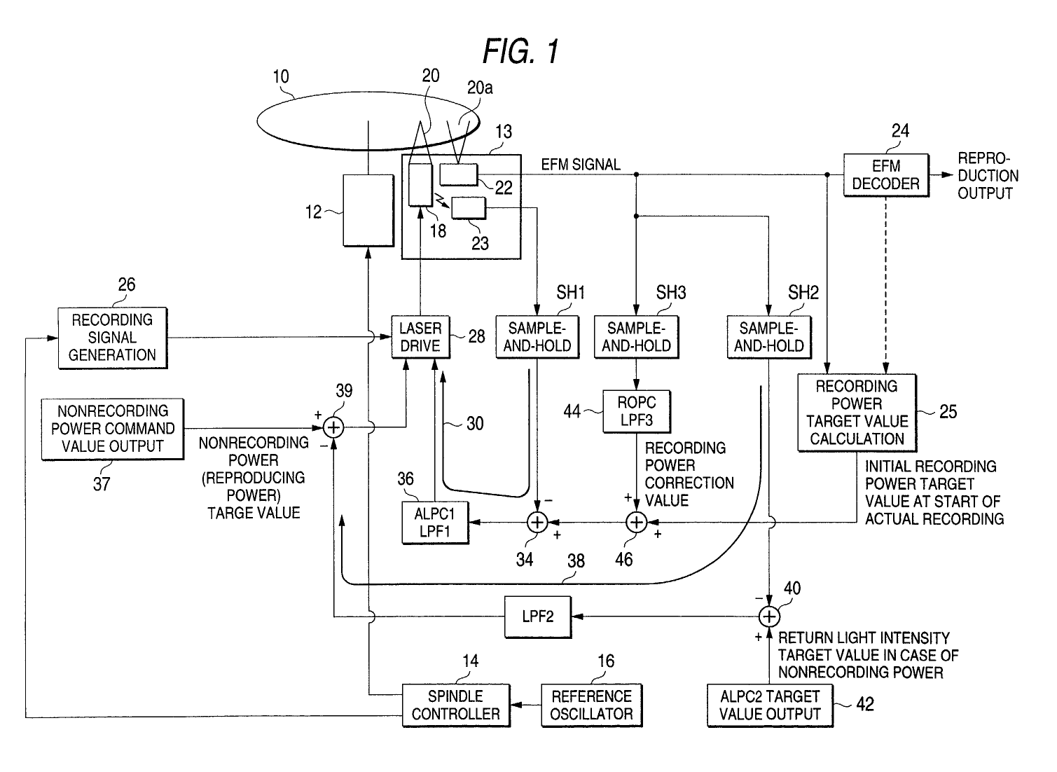

FIG. 1 illustrates a first embodiment of the optical disk recording apparatus according to the invention. This embodiment is adapted to detect an axial runout and an eccentricity at each of circumferential positions on the surface of a disk in real time and to perform recording of information by simultaneously correcting recording power in such a way as to cancel the influence of the axial runout and the eccentricity. An optical disk (that is, a CD-R disk or a CD-RW disk) 10 is driven by a spindle motor 12, and the recording and reproducing of information are performed thereon by an optical pickup 13. A spindle controller 14 is operative to phase-compare a wobble or ATIP (Absolute Time In Pre-groove) signal, which is detected from the optical disk 10, with a signal obtained by frequency-dividing a reference clock generated from a reference oscillator 16, and to then control the spindle motor 12 so that both signals are phase-synchronized with each other. The optical pickup 13 performs recording and reproducing by outputting laser light 20 from a laser light source 18, such as a semiconductor laser, and then irradiating the laser light 20 onto a recording face of the optical disk 10. A part of the laser light 20 outputted from the laser light source 18 is received by a front monitor 23. Return light (that is, reflected light) 20a of a main beam coming from the optical disk 10 is received by a main beam return light detector 22, such as a 4-division photodetector. A reproduced EFM signal outputted from the return light detector 22 during reproduction is EFM-demodulated by an EFM decoder 24, so that a recording signal is demodulated. A recording signal generation circuit 26 generates recording signals for performing test recording and actual recording. A laser drive circuit 28 is a circuit for driving a laser light source 18. When reproduction is performed, the laser drive circuit 28 controls laser light outputs in such a way as to have predetermined reproducing power. When recording is performed, the laser drive circuit 28 modulates the laser light outputs into recording power and nonrecording power in response to recording signals.

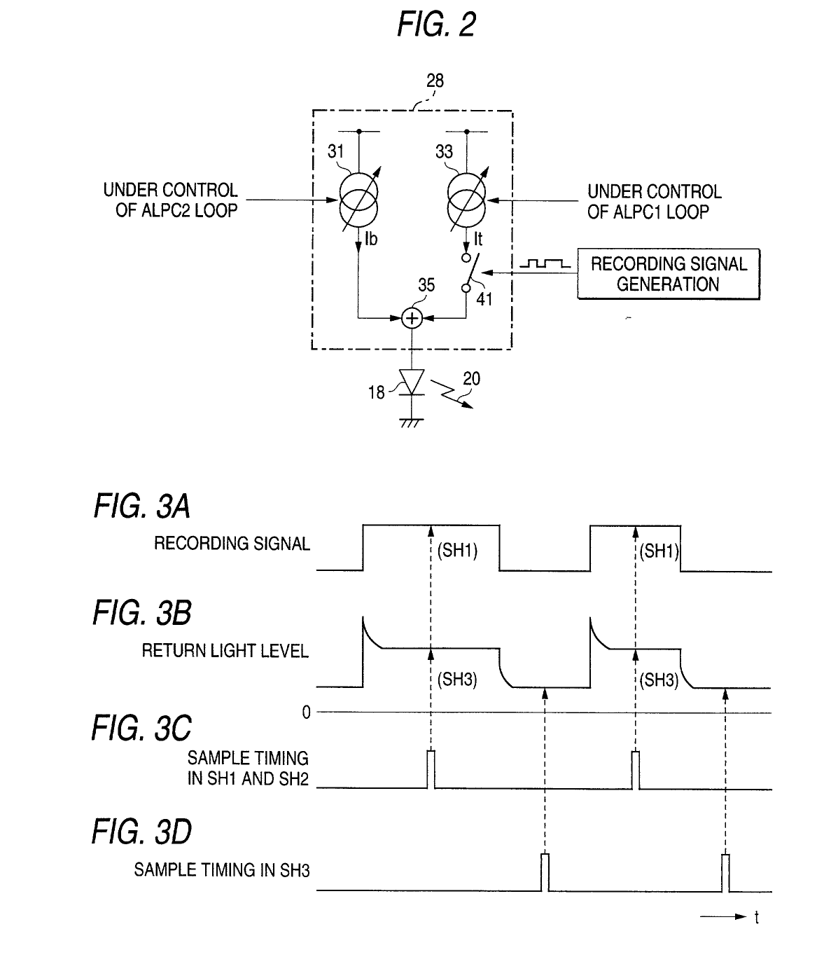

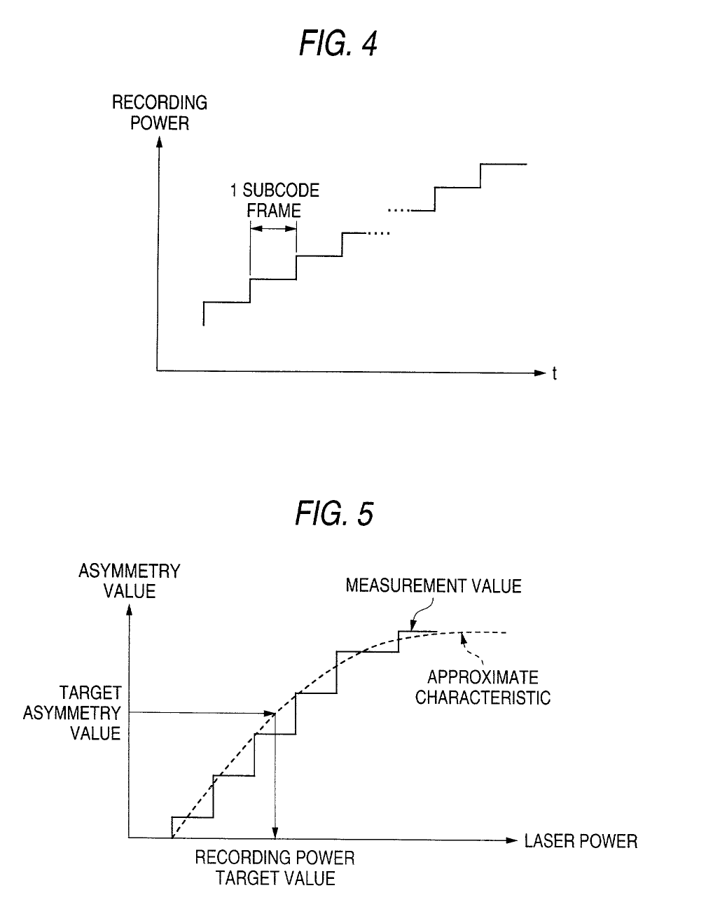

FIG. 2 illustrates an example of the configuration of the laser drive circuit 28. The laser drive circuit 28 has a current source 31 for supplying a laser drive current Ib by which reproducing power to be used in the reproduction and nonrecording power to be used in the recording (that is, the actual recording and the test recording) are realized, and a current source 33 for supplying an electric current It corresponding to the difference between a laser drive current, by which recording power to be used in the reproduction and nonrecording power to be used in the recording (that is, the actual recording and the test recording) is realized, and the current Ib fed from the current source 31. The currents Ib and It respectively supplied from the current sources 31 and 33 are current-added by an adder 35 to thereby drive and cause the laser light source 18 to output the laser light 20. A switch 41 is disposed on a supply path from the current source 33 enabled to provide recording power, and turned on and off in response to recording signals outputted from the recording signal generation circuit 26. Thus, the laser light 20 outputted from the laser light source 18 is modulated into recording power or into nonrecording power in response to recording signals when recording is performed. Further, when reproduction is performed, the switch 41 remains turned off, and the laser light 20 outputted from the laser light source 18 is controlled in such a manner as to have the reproducing power. As shown in FIG. 1, an ALPC1 loop 30 constitutes an ALPC control (Automatic Laser Power Control) loop for controlling recording power, which is used during actual recording, in such a way as to have a value that is equal to a predetermined target value. The ALPC1 loop 30 serves to restrain laser light output from varying owing to change in temperature of the laser light source 18. That is, during actual recording, the ALPC1 loop 30 causes the sample-and-hold circuit SH1 to sample-hold a detection output of the front monitor 23 with the timing (see FIG. 3C) in a recording power mode is used, and then obtains the deviation between a sample-held value of the detection output and a recording power target value at an adding point 34. Then, an ALPC1 circuit 36 controls the laser drive circuit 28 in such a manner as to cancel the deviation (in the case of the configuration of FIG. 2, the current value of the current It from the current source 33 is controlled). Thus, the recording power is controlled in such a way as to have the target value. A low-pass filter LPF1 for setting a response frequency band of the ALPC1 loop 30 is incorporated into the ALPC1 circuit 36. As illustrated in FIG. 4, during the test recording, the ALPC1 circuit 36 designates recording power that changes every predetermined time period (for example, every subcode frame) by a predetermined step.

A nonrecording power command value output circuit 37 issues a command indicating command values that designate nonrecording power to be used during the recording, and that also designate reproducing power to be used during the reproduction. The nonrecording power command value output circuit 37 controls the laser drive circuit 28 to realize the command value (in the case of the configuration of FIG. 2, the current value of the current Ib from the current source 31 is controlled). An ALPC2 loop 38 constitutes an ALPC control loop for controlling a return light detection output in the case, in which nonrecording power is used during the recording (that is, the actual recording and the test recording), in such a way as to have a value that is equal to a predetermined target value. The ALPC2 loop 38 serves to restrain recording quality from being degraded owing to variation in the quantity of the laser light 20 irradiated onto a track, which is caused by an axial runout or an eccentricity. That is, in both the case of performing the test recording and the case of performing the actual recording, the ALPC2 loop 38 causes the sample-and-hold circuit SH2 to sample-hold a detection output of the return light detector 22 with the timing (see FIG. 3D) in a nonrecording power mode is used, and then obtains the deviation between a sample-held value of the detection output and a turn light intensity target value (that is, a value preliminarily set to be a standard value of the return light detection output in the nonrecording power mode), which is outputted from an ALPC2 target value output circuit 42, at an adding point 40. Then, the ALPC2 loop 38 controls the laser drive circuit 28 through the low-pass filter LPF2 and an adding point 39 in such a manner as to cancel the deviation (in the case of the configuration of FIG. 2, the current value of the current Ib from the current source 31 is controlled to be corrected).

A recording power target value calculation circuit 25 measures an asymmetry value (indicated by solid lines in FIG. 5) of each level of the recording power from a reproduced EFM signal. This measured value is approximated by linear approximation, such as a least square method, or by quadratic approximation. Thus, a recording power value-asymmetry value characteristic (indicated by dotted lines in FIG. 5) is obtained. Incidentally, an asymmetry value is given by the following equation:

(an asymmetry value)=(a+b)/(a−b)

where a designates a peak level (sign is “+”) of the waveform of a reproduced EFM signal, and b denotes a bottom level (sign is “−”) thereof. In a memory (not shown) in an optical disk recording apparatus, asymmetry values for realizing high-quality recording are stored as target asymmetry values respectively corresponding to kinds of disks. The optical disk recording apparatus identifies the kind of a disk when the disk is mounted therein. Then, the optical disk recording apparatus reads a corresponding target asymmetry value from the memory. Subsequently, the recording power target value calculation circuit 25 obtains a recording power value (see FIG. 5), by which the target asymmetry value is realized, from the obtained recording power value-asymmetry value characteristic. Then, the obtained value is outputted there from as an initial recording power target value at start of the actual recording.

A sample-and-hold circuit SH3 sample-holds a detection output of the return light detector 22 with the timing (see FIG. 3C) in the recording power mode is used. A ROPC circuit 44 serves to change the target value of the recording power by following variation in optimum recording power owing to rise in the temperature of a disk substrate after the start of actual recording, and to change in thickness of recording film, which is caused at a position in a radial direction of the disk. The ROPC circuit 44 detects an amount of variation between the initial value sample-held by the sample-and-hold circuit SH3 at the start of the actual recording and that subsequently sample-held by the circuit SH3 (incidentally, this variation occurs owing to variation in the return light, which is caused by change in recording conditions, such as a depth). Then, the ROPC circuit 44 generates a correction value to be applied to the recording power target value to thereby cancel the amount of the variation. The generated correction value is added at the adding point 46 to the initial recording power target value at the start of the actual recording. Thus, the recording power target value is corrected. The ALPC1 loop 30 controls laser light output having recording power, which is outputted after the start of the actual recording, by employing this corrected recording power target value as a new recording power target value. A low-pas filter LPF3 for setting the response frequency characteristic itself is incorporated into the ROPC circuit 44.

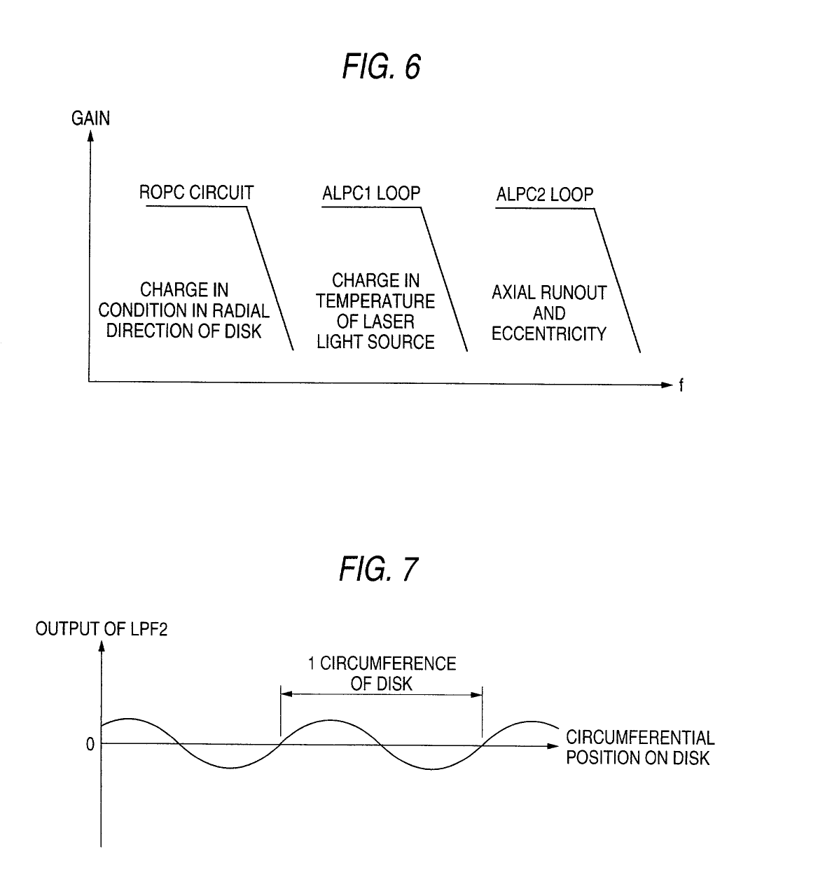

FIG. 6 illustrates examples of setting the response frequency bands of the ALPC1 loop 30, the ALPC2 loop 38, and the ROPC circuit 44 by using the low-pass filters LPF1, LPF2, and LPF3. The response frequency band of the ALPC2 loop 38 is set in a band in which this loop responds to an axial runout and an eccentricity. Thus, during recording, the low-pass filter LPF2 outputs periodical variation components caused owing to an axial runout and an eccentricity, which repeatedly occur every revolution of the disk, as illustrated in FIG. 7. The response frequency band of the ALPC1 loop 30 is set in a band, in which this loop 30 responds to change in the temperature of the laser light source 18 and does not respond to the axial runout and the eccentricity, in such a manner that frequencies of this band are lower than those of-the band in which the response frequency band of the ALPC2 loop 38 is set. The response frequency band of the ROPC circuit 44 is set in a band in which this circuit 44 responds to variation in the return light detection output in the recording power mode caused by change in conditions in a radial direction of the disk during the recording power mode (for instance, rise in the temperature of a disk substrate during the actual recording and variation in thickness of recording film in the radial direction of the disk) in such a way that frequencies of this band are lower than those of the band in which the response frequency band of the ALPC1 loop 30 is set. Thus, the response frequency bands respectively corresponding to control systems are set by dividing a frequency band, so that a stable control is implemented.

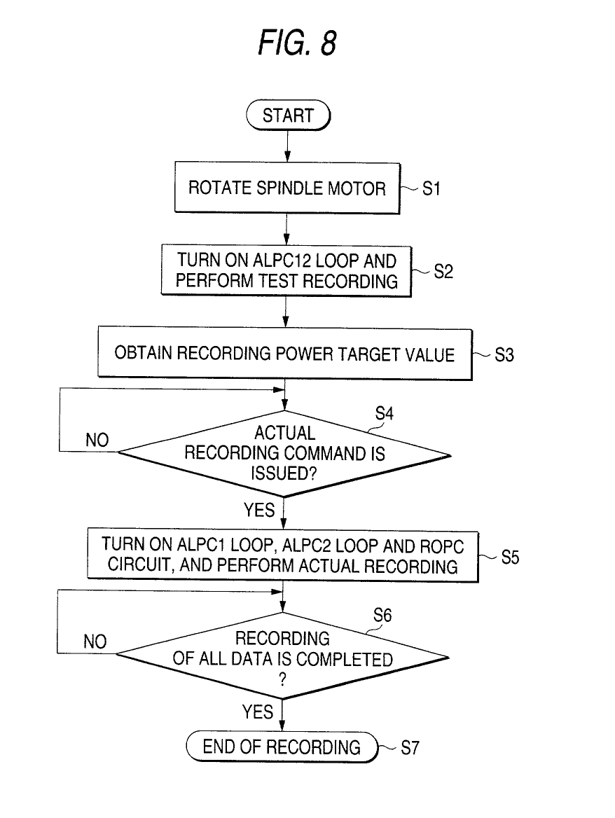

FIG. 8 illustrates an example of a control operation performed by the optical disk recording apparatus shown in FIG. 1. When the optical disk 10 is mounted in the optical disk recording apparatus, a test recording mode is automatically started. That is, at step S1, the spindle motor 12 is activated. Then, the nonrecording power command value output circuit 37 outputs a signal representing a predetermined nonrecording power command value. The ALPC2 target value output circuit 42 outputs a signal indicating a return light intensity target value in the nonrecording power-mode. The ALPC1 circuit 36 issues a command designating recording power that changes in a step-like manner. At step S2, the laser drive circuit 28 modulates a laser light output into recording power and nonrecording power in response to a test EFM signal, and performs test recording. At that time, the ALPC2 loop 38 is in a non-state. Thus, even when the quantity of laser light irradiated onto a track varies owing to the axial runout and the eccentricity occurring in the optical disk 10, a light beam output during the recording power mode is corrected in such a way as to cancel such variation. Thus, the test recording can be performed without being affected by the axial runout and the eccentricity. Incidentally, during the test recording, the following operation maybe performed. That is, the ALPC1 loop 30 is turned off. Further, the recording power is controlled by an open loop according to the recording power command value that is outputted from the ALPC1 circuit 36 and that changes in a step-like manner. At that time, the front monitor 23 detects a real recording power value at each step. Then, the recording power value-asymmetry value characteristic after the test recording can be obtained by using the detected value of the real recording power value at each step. Moreover, during the test recording, the ROPC circuit 44 can be turned off.

At step S3, upon completion of the test recording, the recorded data is reproduced. The asymmetric value the recording power target value calculation circuit 25 measures an asymmetric value (indicated by solid lines in FIG. 5)) at each recording power step. Then, an approximate recording power value-asymmetry value characteristic (indicated by dotted lines in FIG. 5) is obtained from a result of the measurement (that is, data representing an asymmetric value corresponding to the real recording power value at each step). Subsequently, the obtained recording power value is set as an initial recording power target value at the start of an actual recording. Thus, the apparatus is ready to perform the actual recording. When the apparatus is commanded at step S4 to perform actual recording, the nonrecording power command value output circuit 37 outputs a signal representing a predetermined nonrecording power command value, which is equal to the command value used during the test recording. The ALPC2 target value output circuit 42 outputs a signal representing a return light intensity target value, which is equal to that in the case of the test recording, that in the nonrecording power mode. Moreover, the recording power target value calculation circuit 25 outputs a signal representing an initial recording power target value at the start of the actual recording, which is obtained by the test recording. Then, at step 5, the actual recording is started by turning on the ALPC1 loop 30, the ALPC2 loop 38, and the ROPC circuit 44. During the actual recording, the recording power target value is corrected-by the ROPC circuit 44, if necessary. The ALPC1 loop 30 controls the recording power in such a way as to realize the corrected recording target value. The periodical variation in quantity of laser light irradiated onto a track owing to an axial runout and the eccentricity every revolution of the track is canceled by the ALPC2 loop 38. When the recording of actual recording signals is completed at step S6, the actual recoding is finished at step S7.

Second Embodiment

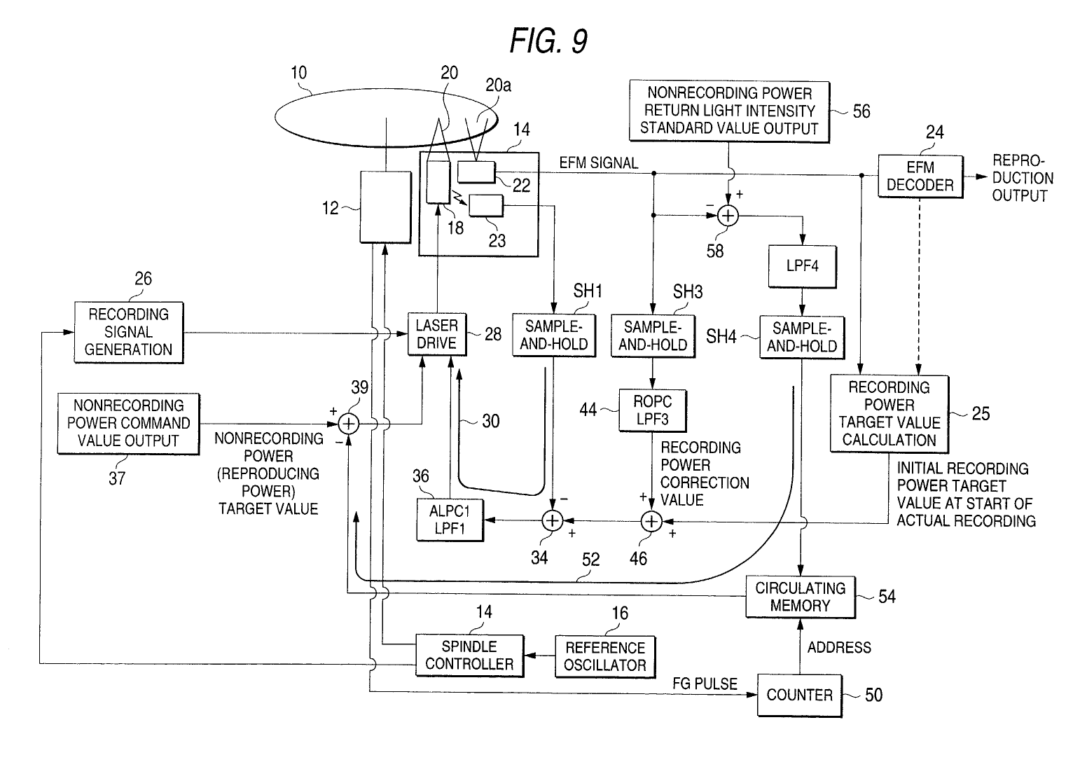

FIG. 9 illustrates an optical disk recording apparatus according to a second embodiment of the invention. This embodiment is adapted so that recording is performed by preliminarily detecting an axial runout and an eccentricity at each of circumferential positions on the surface of the disk, and then storing data representing the detected runout and eccentricity in a memory, and subsequently reading the data from the memory according to the circumferential position, and correcting the recording power in such a way as to cancel the axial runout and the eccentricity. Incidentally, portions, which are common to the first and second embodiments, are designated by like reference characters in the figures. An optical disk 10 is driven by a spindle motor 12. The recording and reproducing of information are performed thereon by an optical pickup 13. A spindle controller 14 is operative to phase-compare a wobble or ATIP signal, which is detected from the optical disk 10, with a signal obtained by frequency-dividing a reference clock generated from a reference oscillator 16, and to then control the spindle motor 12 so that both signals are phase-synchronized with each other. FG pulses are generated by the spindle motor 12 according to the rotation thereof. A counter 50 is reset at a suitable circumferential position on the surface of the optical disk 10, and counts FG pulses. The optical pickup 13 causes the laser light source 18, such as a semiconductor laser, to output laser light 20 from a laser light source 18, and then irradiates the laser light 20 onto a recording face of the optical disk 10. A part of the laser light 20 outputted from the laser light source 18 is received by a front monitor 23. Return light 20a of a main beam coming from the optical disk 10 is received by a main beam return light detector 22, such as a 4-division photodetector. A reproduced EFM signal outputted from the return light detector 22 during reproduction is EFM-demodulated by an EFM decoder 24, so that a recording signal is demodulated. A recording signal generation circuit 26 generates recording signals for performing test recording and actual recording. A laser drive circuit 28 is a circuit for driving a laser light source 18. When reproduction is performed, the laser drive circuit 28 controls laser light outputs in such a way as to have predetermined reproducing power. When recording is performed, the laser drive circuit 28 modulates the laser light outputs into recording power, by which recording is enabled to be performed, and nonrecording power (that is, power that is equal to, for instance, the reproducing power), by which recording is not enabled to be performed, in response to recording signals. The laser drive circuit 28 is configured as illustrated in, for example, FIG. 2.

During actual recording, the ALPC1 loop 30 causes the sample-and-hold circuit SH1 to sample-hold a detection output of the front monitor 23 with the timing (see FIG. 3C) during the recording power is used, and then obtains the deviation between a sample-held value of the detection output and a recording power target value at an adding point 34. Then, an ALPC1 circuit 36 controls the laser drive circuit 28 in such a manner as to cancel the deviation (in the case of the configuration of FIG. 2, the current value of the current It from the current source 33 is controlled). Thus, the recording power is controlled in such a way as to have the target value. A low-pass filter LPF1 for setting a response frequency band of the ALPC1 loop 30 is incorporated into the ALPC1 circuit 36. As illustrated in FIG. 4, during the test recording, the ALPC1 circuit 36 designates recording power that changes every predetermined time period (for example, every subcode frame) by a predetermined step.

A nonrecording power command value output circuit 37 issues a command indicating command values that designate nonrecording power to be used during the recording, and that also designate reproducing power to be used during the reproduction. Further, the nonrecording power command value output circuit 37 controls the laser drive circuit 28 in such a manner as to realize the command value (in the case of the configuration of FIG. 2, the current value of the current Ib from the current source 31 is controlled). A control path 52 serves to restrain recording quality from being degraded owing to variation in the quantity of the laser light 20 irradiated onto a track, which is caused by an axial runout or an eccentricity. This control path 52 detects an axial runout component and an eccentricity component at each of the circumferential positions on the surface of the disk 10 during a training operation to be performed before the test recording, and causes a circulating memory 54 to store the detected components. During test recording and actual recording, according to the circumferential position on the surface of the optical disk 10, the control path 52 reads the corresponding axial runout component and the corresponding axial eccentricity component, and corrects the recording power in such a way as to cancel the axial runout component and the eccentricity component.

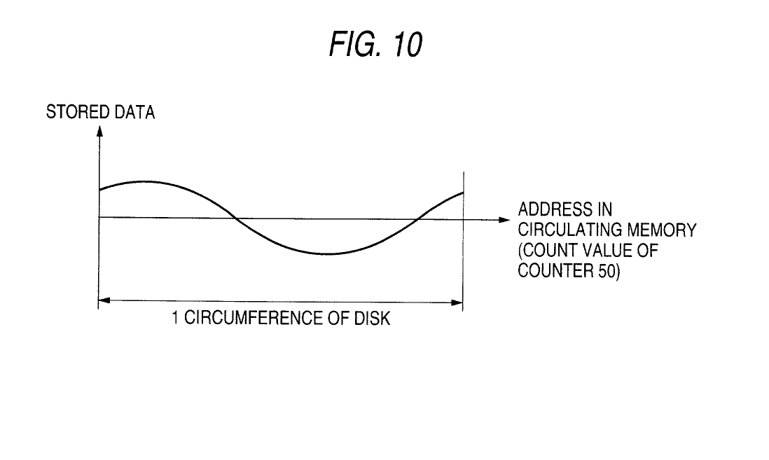

The training operation to be performed before the test recording is performed, for example, in the following manner. The optical disk 10 is rotated and driven. The laser light 20 in the nonrecording power mode (or the reproducing power) the laser light source 18 is outputted from the laser light source 18, and irradiated onto the optical disk 10. Then, the return light 20a is detected by a return light detector 22. A nonrecording power return light intensity standard value output circuit 56 outputs a signal representing a nonrecording power return light intensity standard value (that is, a value preliminarily set to be a standard value of a return light detection output during the nonrecording power mode). At an adding point 58, the deviation between the return light detection output and the nonrecording power return light intensity standard value is obtained. A noise component, whose frequency is higher than the frequencies of the axial runout component and the eccentricity component, is removed from a deviation signal representing this deviation, so that the axial runout component and the eccentricity component are extracted therefrom and inputted to a sample-and-hold circuit SH4. During this state, the counter 50 is reset at a suitable circumferential position on the surface of the optical disk 10. The sample-and-hold circuit SH4 sample-holds the return light detection output at each output of the FG pulse. Then, the sample-held values obtained within 1 circumference of the disk 10, that is, the axial runout components and the eccentricity components obtained at the circumferential positions at the surface of the optical disk 10 during one revolution thereof are stored in the circulating memory 54 by employing the count value of the counter 50 as an address value. FIG. 10 illustrates an example of data stored in the circulating memory 54 during this training operation.

As shown in FIG. 9, a recording power target value calculation circuit 25 measures an asymmetry value (indicated by solid lines in FIG. 5) of each level of the recording power from a reproduced EFM signal when the data recorded during the test recording is reproduced. This measured value is approximated by linear approximation, such as a least square method, or by quadratic approximation. Thus, a recording power value-asymmetry value characteristic (indicated by dotted lines in FIG. 5) is obtained. The recording power target value calculation circuit 25 obtains a recording power value (see FIG. 5), by which the target asymmetry value is realized, from the obtained recording power value-asymmetry value characteristic. Then, the obtained value is outputted therefrom as an initial recording power target value at the start of the actual recording.

A sample-and-hold circuit SH3 sample-holds a detection output of the return light detector 22 with the timing (see FIG. 3C) during the recording power mode. A ROPC circuit 44 detects an amount of variation between the initial value sample-held by the sample-and-hold circuit SH3 at the start of the actual recording and that generates a correction value to be applied to the recording power target value to thereby cancel the amount of the variation. The generated correction value is added at the adding point 46 to the initial recording power target value at the start of the actual recording, so that the recording power target value is corrected. The ALPC1 loop 30 controls laser light output having recording power, which is outputted after the start of the actual recording, by employing this corrected recording power target value as a new recording power target value. A low-pas filter LPF3 for setting the response frequency characteristic is incorporated into the ROPC circuit 44. The response frequency band of the ALPC1 loop 30 is set in a band, in which this loop 30 responds to change in the temperature of the laser light source 18 and does not respond to the axial runout and the eccentricity, in such a manner that frequencies of this band are relatively low. The response frequency band of the ROPC circuit 44 is set in a band in which this circuit 44 responds to variation in the return light detection output caused by change in conditions in a radial direction of the disk during the recording power mode (for instance, rise in the temperature of a disk substrate during the actual recording and-variation in thickness of recording film in a radial direction of the disk) in such a way that frequencies of this band are lower than those of the band in which the response frequency band of the ALPC1 loop 30 is set.

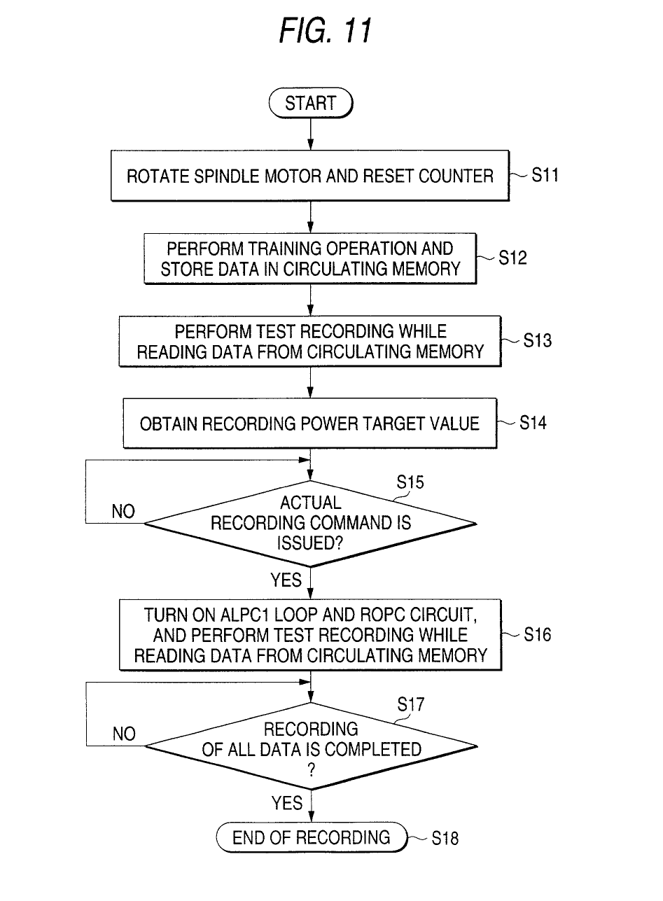

FIG. 11 illustrates an example of a control operation performed by the optical disk recording apparatus shown in FIG. 9. When the optical disk 10 is mounted in the optical disk recording apparatus, a training mode and a subsequent test recording mode are automatically started. That is, at step S11, the spindle motor 12 is activated. Then, the counter 50 is reset at a proper circumferential position on the surface of the optical disk 10. At step S12, the axial runout components and the eccentricity component obtained at the circumferential positions on the surface of the optical disk 10 are stored in the circulating memory 54 by performing the training operation. Upon completion of the training operation, the recording mode is subsequently started. That is, the nonrecording power command value output circuit 37 outputs a signal representing a predetermined nonrecording power command value. The ALPC2 target value output circuit 42 outputs a signal indicating a return light intensity target value in the nonrecording power mode. The ALPC1 circuit 36 issues a command designating recording power that changes in a step-like manner. At step S13, the laser drive circuit 28 modulates a laser light output into recording power and nonrecording power in response to a test EFM signal, and performs test recording. At that time, the counter 50 counts FG pulses and is reset each time the counter 50 reaches the same circumferential position as the position at which the resetting thereof is performed during the training operation. Then, the axial runout components and the eccentricity components at the circumferential positions are serially read from the circulating memory 54 by employing the count value of the counter 50 as address information. The laser drive circuit 28 is controlled through the adding point 39 in such a way as to cancel the axial runout component and the eccentricity component (in the case of the configuration of FIG. 2, the current value of the current Ib outputted from the current source 31 is corrected and controlled). Therefore, even when the quantity of laser light irradiated onto a track varies owing to the axial runout and the eccentricity occurring in the optical disk 10, a light beam output during the recording power mode is corrected in such a way as to cancel such variation. Thus, the test recording can be performed without being affected by the axial runout and the eccentricity. Incidentally, during the test recording, the following operation may be performed. That is, the ALPC1 loop 30 is turned off. Further, the recording power is controlled by an open loop according to the recording power command value that is outputted from the ALPC1 circuit 36 and that changes in a step-like manner. At that time, the front monitor 23 detects a real recording power value at each step. Then, the recording power value-asymmetry value characteristic after the test recording can be obtained by using the detected value of the real recording power value at each step. Moreover, during the test recording, the ROPC circuit 44 can be turned off.

At step S14, upon completion of the test recording, the recorded data is reproduced. Further, the asymmetric value the recording power target value calculation circuit 25 measures an asymmetric value (indicated by solid lines in FIG. 5)) at each recording power step. Then, an approximate recording power value-asymmetry value characteristic (indicated by dotted lines in FIG. 5) is obtained from a result of the measurement (that is, data representing an asymmetric value corresponding to the real recording power value at each step). Subsequently, the obtained recording power value is set as an initial recording power target value at the start of an actual recording. Thus, the apparatus is ready to perform the actual recording. When the apparatus is commanded at step S15 to perform actual recording, the nonrecording power command value output circuit 37 outputs a signal representing a predetermined nonrecording power command value, which is equal to the command value used during the test recording. Moreover, the recording power target value calculation circuit 25 outputs a signal representing an initial recording power target value at the start of the actual recording, which is obtained by the test recording. Then, at step S16, the actual recording is started by turning on the ALPC1 loop 30, and the ROPC circuit 44. During the actual recording, similarly as the apparatus performs during the test recording, the axial runout components and the eccentricity components at the circumferential positions are sequentially read from the circulating memory 54 by employing the count value of the counter 50 as address information. The laser drive circuit 28 is controlled through the adding point 39 in such a way as to cancel the axial runout component and the eccentricity component (in the case of the configuration of FIG. 2, the current value of the current Ib outputted from the current source 31 is corrected and controlled). Moreover, during the actual recording, the recording power target value is corrected by the ROPC circuit 44, if necessary. The ALPC1 loop 30 controls the recording power in such a way as to realize the corrected recording target value. When the recording of actual recording signals is completed at step S17, the actual recoding is finished at step S18.

Incidentally, in the first and second embodiments, the axial runout components and the eccentricity components are detected from the return light during the nonrecording power is used. However, the axial runout components and the eccentricity components may be detected from the return light during the recording power is used. At that time, in the case that the laser drive circuit 28 is configured as illustrated in FIG. 2, the axial runout components and the eccentricity components can be canceled by controlling the current value of the current It outputted from the current source 33 according to the detected axial runout component and the detected eccentricity component.

Third Embodiment

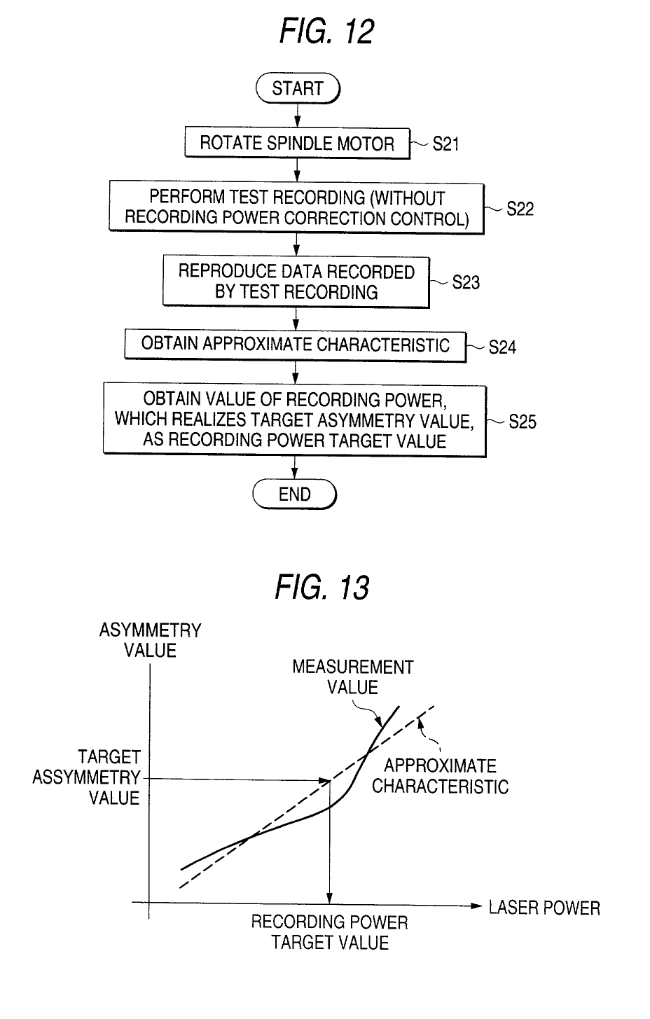

Although the recording power is corrected according to the axial runout component and the eccentricity component during the test recording in the first and second embodiments, recording power for realizing the target asymmetry value can be obtained with high precision by performing the test recording without performing correction and eliminating the axial runout component and the eccentricity component when the recording power value-asymmetry value characteristic is obtained from the data that is obtained by the test recording and reproduced. An example of a control operation in the case of realizing this in the configurations of the first and second embodiments is described hereinbelow with reference to FIG. 12. When the optical disk 10 is mounted in the optical disk recording apparatus, a test recording mode is automatically started. That is, at step S21, the spindle motor 12 is activated. The nonrecording power command value output circuit 37 outputs a signal representing a predetermined nonrecording power command value. At step S22, the ALPC1 circuit 36 issues a command designating recording power that changes in a step-like manner. Furthermore, the laser drive circuit 28 modulates a laser light output into recording power and nonrecording power in response to a test EFM signal, and performs test recording. At that time, in the case of the configuration of FIG. 1, the ALPC2 loop 38 is turned off, while in the case of the configuration of FIG. 9, the control path 52 is turned off to thereby stop an operation of correcting the recording power. The number of steps of the recording power is set so that this test recording is completed during just or almost one revolution of the disk. Incidentally, during the test recording, the ALPC1 loop 30 is turned off. Further, the recording power is controlled by an open loop according to the recording power command value that is outputted from the ALPC1 circuit 36 and that changes in a step-like manner. At that time, the front monitor 23 detects a real recording power value at each step. Then, the recording power value-asymmetry value characteristic after the test recording can be obtained by using the detected value of the real recording power value at each step. Moreover, during the test recording, the ROPC circuit 44 can be turned off.

At step S23, after the test recording, data obtained by the test recording is reproduced. Then, the recording power target value calculation circuit 25 measures an asymmetry value. Further, an approximate recording power value-asymmetry value characteristic (indicated by a dotted line in FIG. 13) is obtained from a result of the measurement (that is, data representing an asymmetry value corresponding to a real recording power value (see a curve indicated by solid lines in FIG. 13)) by a least square method. Because the test recording is completed during just or almost one revolution of the disk, this approximate characteristic is obtained by eliminating the influence of the axial runout component and the eccentricity component. Therefore, the recording power for realizing the target asymmetry value is obtained with high accuracy from the approximate characteristic at step S25. The obtained recording power value is set to be the initial recording power target value at the start of the actual recording. Thus, the apparatus is ready for the actual recording. The actual recording can be started by issuing an actual recording command. Incidentally, during the actual recording, the recording power correction, which has been described in the foregoing description of the first and second embodiments, can be performed according to the axial runout component and the eccentricity component.

Fourth Embodiment

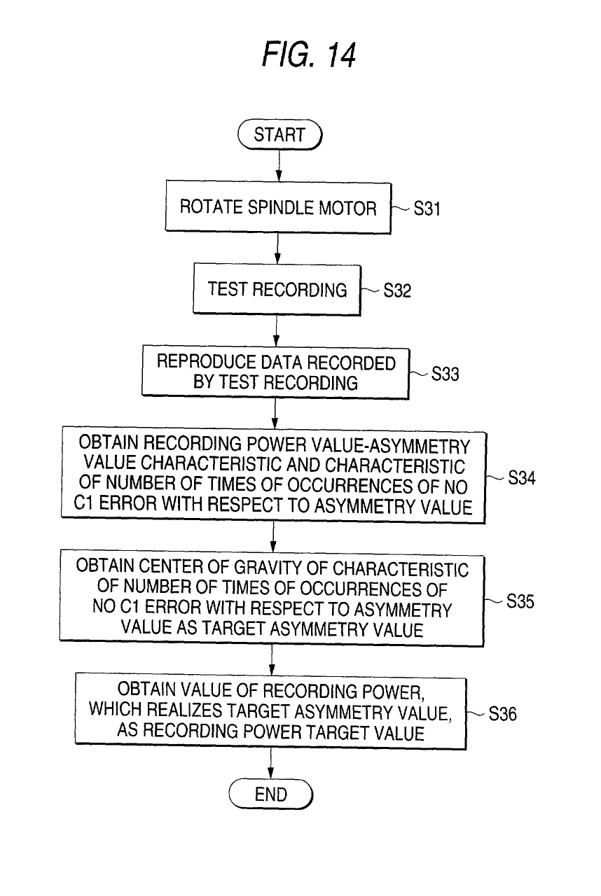

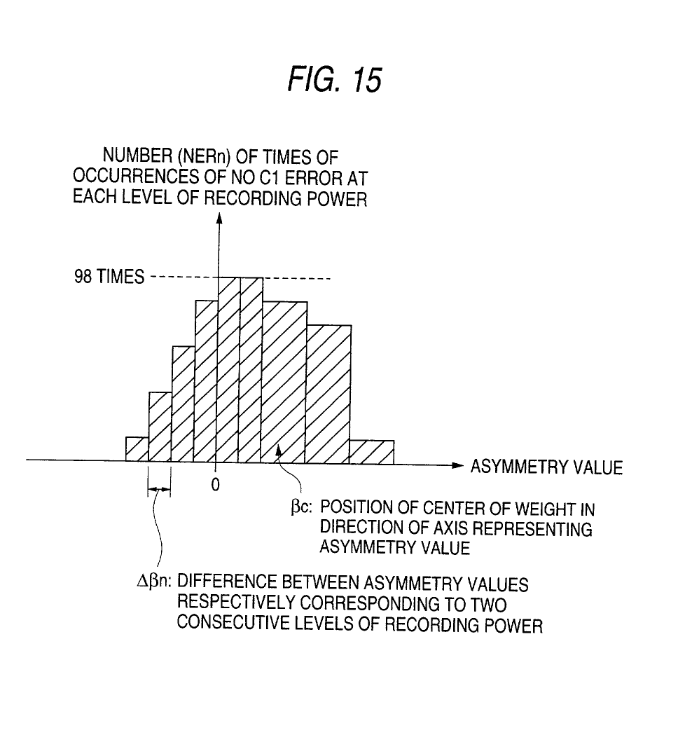

In the foregoing description of the first to third embodiments, it is assumed that the target asymmetry value is preliminarily stored in the memory. However, sometimes, there is caused the necessary for obtaining the target asymmetry value in a stage in which a user uses the recording apparatus, for example, when the target asymmetry value is not preliminarily stored in the memory, or when the target asymmetry value is preliminarily stored therein and the user wishes to obtain the target asymmetry value with higher accuracy. An example of a control operation in the case of realizing this in the configurations of the first to third embodiments is described hereinbelow with reference to FIG. 14. When the optical disk 10 is mounted in the optical disk recording apparatus, a test recording mode is automatically started. That is, at step S31, the spindle motor 12 is activated. Further, the recording power changes in a step-like manner. Thus, the test recording is performed at step S32. Upon completion of the test recording, data obtained by the test recording is reproduced at step S33. Then, the recording power target value calculation circuit 25 measures an asymmetry value corresponding to each of the recording power steps. An approximate recording power value-asymmetry value characteristic is obtained from a result of the measurement by performing a least square method. Furthermore, the recording power target value calculation circuit 25 measures the number of occurrences of C1 errors at each of the recording power steps from a result of decoding performed by an EFM decoder 24. In the case that a time period corresponding to 1 step is 1 subcode frame (=98 EFM frames), the maximum number of occurrences of C1 errors is 98. Thus, at step S34, characteristic of number of times of occurrence of no c1 error with respect to asymmetry value is obtained by employing a value, which is obtained by subtracting the number of times of occurrences of C1 errors from 98 as the number of times of occurrence of no C1 errors. FIG. 15 illustrates an example of characteristic of number of times of occurrence of no c1 error with respect to asymmetry value obtained by in such a way. The recording power target value calculation circuit 25 determines the center of gravity in the direction of the axis representing the asymmetry value from the obtained characteristic of number of times of occurrence of no c1 error with respect to asymmetry value. That is, the number NERn of times of occurrence of no C1 error is multiplied by the difference Δβn between asymmetric values respectively corresponding to two consecutive levels of the recording power. Then, a total sum of values obtained by such multiplication is calculated. Thus, a parameter value SQ given by the following equation and used for evaluating the quality of the recorded signal:

SQ=Σβn*NERn

Then, the center of gravity βc in the direction of the axis representing the asymmetry value-is obtained by the following equation by dividing the value SQ by a total number of the value NERn of times of occurrence of no C1 error, which is computed for all the levels respectively corresponding to the steps of the recording power:

βc=SQ/ΣNERn

The obtained asymmetry value is a value enabled to provide a large power margin, and set to be a target asymmetry value at step S35. When the target asymmetry value is obtained, recording power realizing the target asymmetry value is obtained from the approximate recording-power-value-asymmetry-value characteristic at step S36. The obtained recording power value is set to be an initial recording power target value at the start of the actual recording. Thus, the apparatus becomes ready for the actual recording. Then, the actual recording can be commenced by issuing an actual recording command. Incidentally, during the actual recording, the recording power correction described in the foregoing description of the first and second embodiments can be performed according to the axial runout component and the eccentricity component.

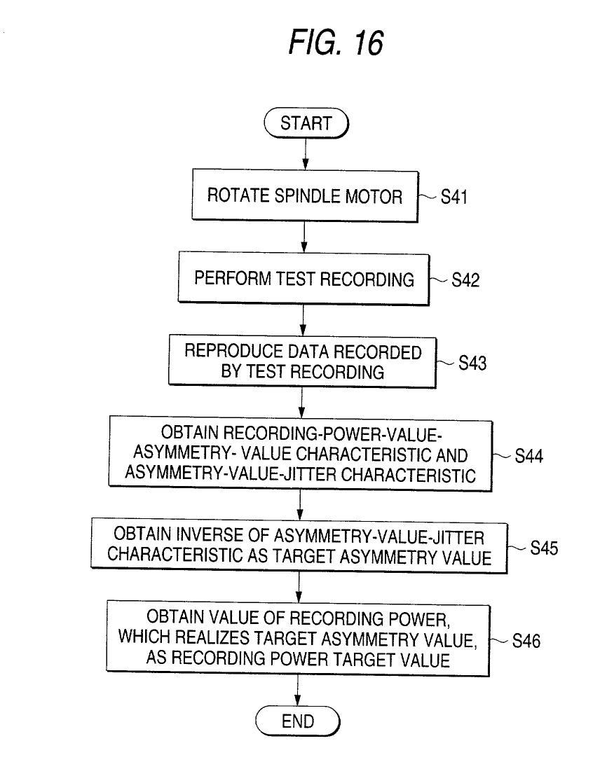

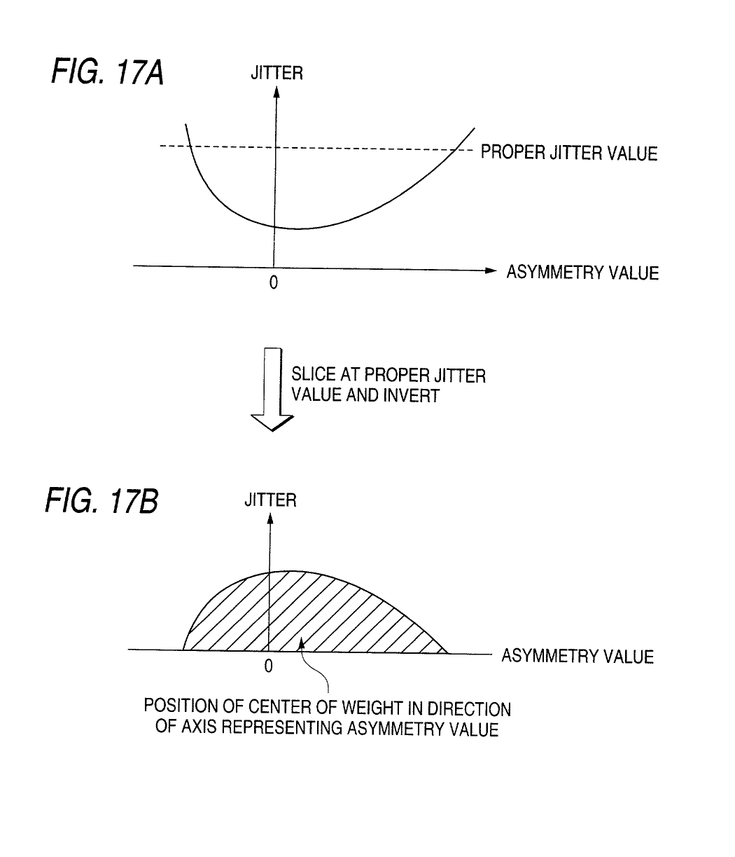

Incidentally, a jitter characteristic may be used instead of the C1 error characteristic. An example of a control operation in this case is described with reference to FIG. 16. When an optical disk 10 is mounted-in the optical disk recording apparatus, the test recording mode is automatically started. That is, at step S41, the spindle motor 12 is activated. Then, at step S42, the recording power changes in a step-like manner, so that the test recording is performed. Upon completion of the test recording, data obtained by the test recording is reproduced at step S43. Subsequently, at step S44, the recording power target value calculation circuit 25 measures an asymmetry value corresponding to each recording power step. An approximate recording power value-asymmetry value characteristic is obtained from a result of the measurement by a least square method. Furthermore, the recording power target value calculation circuit 25 measures a jitter (that is, a time-base error) from the reproduced EFM signal representing the value reproduced from the data obtained by the test recording, and obtains the jitter corresponding to each of the asymmetry values. FIG. 17A illustrates an example of the (approximate) asymmetry-value-jitter characteristic obtained in this manner. Then, a curve representing the obtained asymmetry-value-jitter characteristic is “sliced” at a proper jitter value. Subsequently, the resultant curve is inverted, as shown in FIG. 17B. Then, the asymmetry value corresponding to the center of gravity of an area surrounded by the inverted curve and the axis representing the asymmetry value is obtained and set to be a target asymmetry value at step S45. When the target asymmetry value is obtained, the recording power realizing the target asymmetry value is found from the approximate recording-power-value-asymmetry-value characteristic at step S46. The, the found recording power value is set to be an initial recording power target value at the start of the actual recording. Thus, the apparatus becomes ready for the actual recording. Then, the actual recording can be commenced. During the actual recording, the recording power correction described in the foregoing description of the first and second embodiments can be performed according to the axial runout component and the eccentricity component.

Incidentally, although the case of applying the invention to a CD-R/RW drive has been described in the foregoing description of each of the aforementioned embodiments, the invention can be applied not only thereto but an optical disk drive, such as a DVD recording drive.

What is claimed is:

1. An optical disk recording method of modulating a light beam into recording power by which recording is enabled to be performed and nonrecording power by which recording is not enabled to be performed according to a recording signal, and for irradiating the modulated light beam onto a track of an optical disk to thereby perform recording of the recording signal, the method comprising the steps of:
detecting periodical variation components included in a light beam return light detection output, which repeatedly occur in response to revolution of the disk; and
correcting a light beam output in a recording mode so as to cancel the periodical variation components.

2. An optical disk recording method of modulating a light beam into recording power by which recording is enabled to be performed and nonrecording power by which recording is not enabled to be performed according to a recording signal and for irradiating the modulated light beam onto a track of an optical disk to thereby perform recording of the recording signal, the method comprising the steps of:
detecting a light beam output in a recording power mode;
controlling the light beam output so that a value thereof is equal to a predetermined target value;
detecting periodical variation components of a light beam return light detection output which repeatedly occurs in response to revolution of the disk; and
correcting the light beam output in the recording power mode in a response frequency band whose frequencies differ from those used for controlling the light beam output according to detection of the optical beam output in the recording power mode so as to cancel the periodical variation components.

3. An optical disk recording apparatus for modulating a light beam into recording power by which recording is enabled to be performed and nonrecording power by which recording is not enabled to be performed according to a recording signal, and for irradiating the modulated light beam onto a track of an optical disk to thereby perform recording of the recording signal, the apparatus comprising:
a recording power control loop for detecting a light beam output in a recording power mode, and for controlling the light beam output in the recording power mode so that a value of the light beam output is equal to a predetermined target value; and
a nonrecording power control loop for detecting a light beam return light in a nonrecording power mode, and for controlling a return light detection output in the nonrecording power mode so that a value of the light beam output is equal to a predetermined target value,
wherein a response frequency band of the nonrecording power control loop is set in a band in which the nonrecording power control loop responds to periodical variation components of the light beam return light detection output, which repeatedly occur in response to revolution of said disk,
wherein a response frequency band of the recording power control loop is set in a relatively low-frequency band in which the recording power control loop does not respond to the periodical variation components of the light beam return light detection output, and
wherein during the recording power mode, the recording power control loop drives a light beam source according to a synthetic value of a light beam drive signal generated in the recording power control loop, and a light beam drive signal generated in the nonrecording power control loop, and controls the light beam output so that a value of the light beam output is equal to a predetermined target value in the recording power mode.

4. The optical disk recording apparatus according to claim 3 further comprising:
a recording power target value correcting unit for detecting variation in the light beam return light detection output in the recording power mode, which is caused by movement of a recording position in a radial direction of the disk, for generating a correction value for canceling the variation in the return light detection output in the recording power mode, and for correcting the target value of the recording power control loop by using the correction value,
wherein a response frequency band of the recording power target value correcting unit is set in a frequency band differing from a response frequency band of the recording power control loop.

5. An optical disk recording method of modulating a light beam into recording power by which recording is enabled to be performed and nonrecording power by which recording is not enabled to be performed according to a recording signal, and for irradiating the modulated light beam onto a track of an optical disk to thereby perform recording of the recording signal, the method comprising the steps of:
detecting periodical variation components of a light beam return light detection output, which repeatedly occur in response to revolution of the disk, before recording;
preliminarily storing the detected periodical variation components in a memory as a periodical variation characteristic of the light beam return light output with respect to circumferential positions on a surface of the disk;
sequentially detecting the circumferential positions during recording;
sequentially reading the periodical variation components of the light beam return light detection output from the memory which correspond to the detected circumferential positions; and
correcting the light beam output in the recording power mode so as to cancel the periodical variation components.

6. The method according to claim 5, wherein detection of the periodical variation components of the light beam return light detecting output is performed by irradiating a light beam having predetermined power, at which recording is not performed, on the optical disk.

7. An optical disk recording method of modulating a light beam into recording power by which recording is enabled to be performed and nonrecording power by which recording is not enabled to be performed according to a recording signal, and for irradiating the modulated light beam onto a track of an optical disk to thereby perform recording of the recording signal, the method comprising the steps of:
detecting periodical variation components of a light beam return light detection output, which repeatedly occur in response to a revolution of the disk;
preliminarily storing the detected periodical variation components in a memory as a periodical variation characteristic of the light beam return light output with respect to circumferential positions on a surface of the disk;
detecting a light beam output in the recording power mode during recording;
controlling the light beam output in a first response frequency band so that a value of the light beam output is equal to a predetermined target value;
sequentially detecting circumferential positions on a surface of the disk;
sequentially reading the periodical variation components of the light beam return light detection output corresponding to the detected circumferential positions from the memory; and
correcting the light beam output in the recording power mode in a response frequency band which differs from the first response frequency band so as to cancel the periodical variation components.

8. The method according to claim 7, wherein detection of the periodical variation components of the light beam return light detecting output is performed by irradiating a light beam having predetermined power, at which recording is not performed, on the optical disk.

9. An optical disk recording apparatus for modulating a light beam into recording power by which recording is enabled to be performed and nonrecording power by which recording is not enabled to be performed according to a recording signal, and for irradiating the modulated light beam onto a track of an optical disk to thereby perform recording of the recording signal, the apparatus comprising:
a memory for storing detected characteristics of periodical variation components of a light beam return light detection output, which occur repeatedly in response to revolution of the optical disk mounted in the apparatus, corresponding to each of circumferential positions on a surface of the optical disk;
a recording power control loop for detecting a light beam output in the recording power mode, and for controlling the light beam output in the recording power mode so that a value of the light beam output is equal to a predetermined target value;
a circumferential position detecting unit for detecting a circumferential position, at which recording is performed, on a surface of said disk; and
a light beam output correcting unit for sequentially reading the periodical variation components of the light beam return light detection output, which are caused at corresponding circumferential positions on the surface of the optical disk, from the memory correspondingly to the detected circumferential positions and for correcting the light beam output in the recording power mode so as to cancel the periodical variation components,
wherein a response frequency band of the recording power control loop is set in a frequency band in which the recording power control loop does not respond to an light beam output correction performed by the light beam output correcting unit.

10. The optical disk recording apparatus according to claim 9 further comprising:
a recording power target value correcting unit for detecting variation in the light beam return light detection output in the recording power mode, which is caused by movement of a recording position in a radial direction of the optical disk, for generating a correction value for canceling the variation in the return light detection output in the recording power mode, and for correcting the target value of the recording power control loop by using the correction value,
wherein a response frequency band of the recording power target value correcting unit is set in a frequency band differing from the response frequency band of the recording power control loop.

11. An optical disk recording method of modulating a light beam into recording power by which recording is enabled to be performed and nonrecording power by which recording is not enabled to be performed according to a recording signal and for irradiating the modulated light beam onto a track of an optical disk to thereby perform recording of the recording signal, the method comprising the steps of:
performing test recording by serially changing the recording power for one revolution of the disk before actual recording;
measuring an asymmetry value in the recording power mode by reproducing data obtained by the test recording;
obtaining a linear or quadratic approximate characteristic of recording power value-asymmetry value from the measured asymmetry value;
obtaining a recording power value for realizing a predetermined target value of the asymmetry value from the obtained linear or quadratic approximate characteristic; and
setting the obtained recording power value to be an initial recording power command value at start of the actual recording to thereby commence the actual recording.

12. An optical disk recording method of modulating a light beam into recording power by which recording is enabled to be performed and nonrecording power by which recording is not enabled to be performed according to a recording signal and for irradiating the modulated light beam onto a track of an optical disk to thereby perform recording of the recording signal, the method comprising the steps of:
performing test recording by changing the recording power for one revolution of the disk before actual recording;
obtaining a recording power value-asymmetry value characteristic and an asymmetric value-recording signal quality characteristic by reproducing data obtained by the test recording;
obtaining a position of a center of gravity in a direction in which an asymmetry value changes from the asymmetric value-recording signal quality characteristic;
obtaining a recording power value for realizing a predetermined target value of the asymmetry value from the obtained recording power value-asymmetry value characteristic; and
setting the obtained recording power value to be an initial recording power command value at start of the actual recording to thereby commence the actual recording.
